(19) United States
(12) Patent Application Publication
(10) Pub. No.: US 2009/0252664 A1
(43) Pub. Date: Oct. 8, 2009

(54) METHODS AND APPARATUS FOR HEATING REAGENTS AND EFFLUENTS IN ABATEMENT SYSTEMS

(75) Inventors: Robbert M. Vermeulen, Pleasant Hill, CA (US); Daniel O. Clark, Pleasanton, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/372,729

(22) Filed: Feb. 17, 2009

Related U.S. Application Data
(60) Provisional application No. 61/029,455, filed on Feb. 18, 2008.

(51) Int. Cl. B01D 53/75; B01J 19/00; A62D 3/40

(52) U.S. Cl. 423/210; 422/198; 422/199

(57) ABSTRACT

In some aspects, an apparatus for abating effluent from an electronic device manufacturing process tool is provided, including: a reaction chamber adapted to receive an effluent; and a reagent heating apparatus in fluid connection with the reaction chamber; wherein the reagent heating apparatus is adapted to heat a reagent and to introduce the heated reagent into a heated reagent reaction zone of the reaction chamber; and wherein the reaction chamber is further adapted to mix the effluent and the heated reagent in the heated reagent reaction zone. Other apparatus and methods are disclosed.

The present application claims priority to U.S. Provisional Patent Application Ser. No. 61/029,455, filed Feb. 18, 2008, and entitled “METHODS AND APPARATUS FOR HEATING REAGENTS IN ABATEMENT SYSTEMS” (Attorney Docket No. 11629/L), which is hereby incorporated herein by reference in its entirety for all purposes.

### FIELD OF THE INVENTION

The present invention relates to electronic device manufacturing, and more specifically to methods and apparatus for abating effluent gases from electronic device process chambers and tools.

### BACKGROUND OF THE INVENTION

Conventional abatement systems may abate (e.g., reduce toxicity, flammability, etc.) electronic device manufacturing effluent (hereinafter “effluent”) so that they may be directed to a facility exhaust system. Effluent may include a stream of fluids that is produced during fabrication of various devices (e.g., electronic, electro-mechanical, etc.). Conventional abatement systems may abate effluent so that the exhaust output from the facility may comply with various regulatory standards and be less harmful to the environment. Abating effluent may include abating harmful or undesirable compounds in the effluent.

In order to abate the effluent, heat may be employed to ‘break apart’, or create free radicals of, the compounds in the effluent. This breaking apart of the compounds typically results in radicals (e.g., ions of the elements forming the compounds) that are free to react with a reagent, for example, air, oxygen enriched air or oxygen, thereby forming a more desirable, or less harmful, compound. Heat may be required to be added to the system in order to enable the reaction of the effluent with the reagent to proceed.

The amount of heat required to break apart the compounds to form the radicals may vary with the type and strength of the bonds between atoms in a compound. For example, some compounds have covalent bonds. It is known that the ‘triple’ covalent bond may require a higher temperature to separate (e.g., ‘break apart’) than three ‘single’ covalent bonds. For example, NF₃ has three ‘single’ covalent bonds. In contrast, carbon monoxide (CO) has one ‘triple’ covalent bond. Thus, the carbon monoxide compound may require more heat (and therefore more fuel) to break apart in comparison with the NF₃. Other considerations such as electro negativity, the size of the atoms, etc. may also play a role in the strength of the bonds in a compound. Thus, to fully abate a particular effluent, the abatement system may be required to heat the effluent to a selected high temperature. This selected temperature may be higher than a temperature needed to abate some compounds in the effluent, but may be required to fully abate the effluent, if the effluent contains compounds which require the selected high temperature to be abated.

It is known that certain high temperatures may be achieved by burning fuel. The use of large amounts of fuel, or any fuel at all, however, may be undesirable for a number of reasons. Fuel may be expensive, and the use of fuel may require one or more regulatory approvals. Additionally, fuel may be explosive, and therefore inherently unsafe, forcing the abatement operator to take appropriate precautions. Such precautions may require retrofitting equipment, and/or building safety devices, etc. Such safety precautions may be expensive to implement. In some abatement scenarios, the use of some fuel may be unavoidable, but even in these cases, merely reducing the amount of fuel required may be desirable to lessen cost and ease safety concerns. Accordingly, there is a need to reduce the use of fuel in abatement systems while still fully abating effluent.

### SUMMARY OF THE INVENTION

In some aspects, an apparatus for abating effluent from an electronic device manufacturing process tool is provided, including: a reaction chamber adapted to receive an effluent; and a reagent heating apparatus in fluid connection with the reaction chamber; wherein the reagent heating apparatus is adapted to heat a reagent and to introduce the heated reagent into a heated reagent reaction zone of the reaction chamber; and wherein the reaction chamber is further adapted to mix the effluent and the heated reagent in the heated reagent reaction zone.

In some aspects, an apparatus for abating effluent from an electronic device manufacturing process tool is provided, including: an effluent heating apparatus adapted to heat an effluent without burning a fuel; and a reaction chamber; wherein the effluent heating apparatus is further adapted to introduce the heated effluent into the reaction chamber; and wherein the reaction chamber is adapted to receive a reagent into the heated effluent reaction zone and to mix the heated effluent with the reagent in the heated effluent reaction zone, whereby the heated effluent is abated.

In some aspects, a method for abating effluent from an electronic device manufacturing process tool is provided, including: heating a reagent; mixing the heated reagent with an effluent in a heated reagent reaction zone of a reaction chamber, whereby heat is transferred from the heated reagent to the effluent; and reacting the effluent with the heated reagent, whereby the effluent is abated.

In some aspects, a method for abating effluent from an electronic device manufacturing process tool, comprising: heating an effluent without combusting a fuel; mixing the heated effluent with a reagent in a heated effluent reaction zone of a reaction chamber, whereby heat is transferred from the heated effluent to the reagent; and reacting the heated effluent with the reagent, whereby the effluent is abated.

Other features and aspects of the present invention will become more fully apparent from the following detailed description, the appended claims and the accompanying drawings.

### SUMMARY OF THE DRAWINGS

FIG. 1 depicts a flow chart of a first method of reagent heating provided in accordance with at least one embodiment of the present invention.

FIG. 2 depicts a schematic view of a system for abating effluent, including heating the reagent, provided in accordance with at least one embodiment of the present invention.

FIG. 2A depicts a schematic view of an alternative system for abating effluent, including heating the reagent, provided in accordance with at least one embodiment of the present invention.

FIG. 3 depicts a flow chart of a second method of forming a more desirable compound with heated reagent provided in accordance with the present invention.

FIG. 4 depicts a cross section side view of a exemplary heating conduit provided in accordance with the present invention.

FIG. 5 depicts a heated effluent abatement system provided in accordance with the present invention.

### DETAILED DESCRIPTION

In some embodiments, the present invention provides methods and apparatus that heat reagent and/or effluent without fuel in order to create free radicals of the reagent and/or the effluent, and to abate the effluent. The reagent and/or effluent may be heated without burning fuel using a heating element (e.g., electrical resistance heater), a plasma torch, and/or radiation (e.g., RF, microwaves, etc.). Any other suitable, non-fuel burning heating method may be employed.

In some embodiments, the reagent may be heated without fuel outside of the reaction chamber prior to being supplied to the reaction chamber where it may mix with effluent, transfer heat to the effluent and react with the heated effluent. In other embodiments, the effluent may be heated without fuel outside of the reaction chamber, and then supplied to the reaction chamber where it may mix and react with the reagent. In yet other embodiments, both the reagent and the effluent may be heated outside of the reaction chamber prior to being supplied to the reaction chamber where they can mix and react.

In some embodiments, for example, reagent which has been heated without fuel may both ‘break apart’ and react with the effluent compounds in the reaction chamber. In contrast to using fuel that combusts in the reaction chamber to raise the temperature of an effluent and a reagent, the heated reagent may be used to heat the effluent compounds. Thus, heated reagent (e.g., air, oxygen enriched air, or molecular oxygen) may transfer heat to effluent compounds (e.g., CF₄, C₂F₆, C₃F₈, etc.) to ‘break apart’ are dissociate the effluent compounds to form effluent radicals. Thereafter, heated reagent may also provide a reagent radical that bonds with the effluent radical to form more desirable compounds. That is, heated reagent may both heat both the effluent compounds and provides the reagent radical that may bond with the effluent radicals to form the more desirable compound. Such heating may be more direct in contrast to using fuel (and therefore may be more efficient). Additionally, such heating may reduce or eliminate the need to employ fuel in abatement systems.

In still other embodiments, the heating of reagent and/or effluent without fuel may be supplemented with combusted fuel based heating.

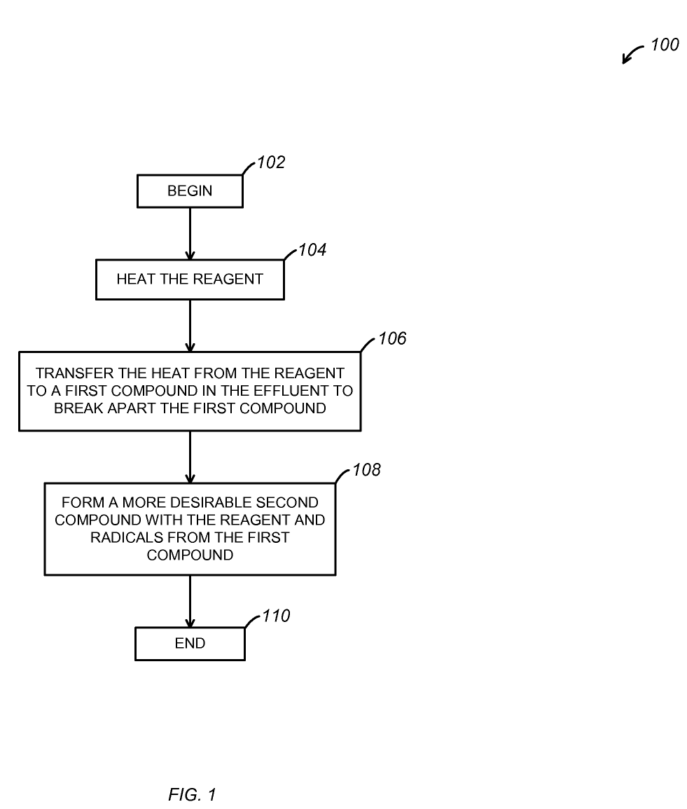

These and other aspects of the inventions are described below with reference to FIGS. 1-5.

FIG. 1 depicts a flow chart of a first method of abating effluent 100 provided in accordance with the present invention. The first method of abating effluent 100 begins with step 102 which is followed by step 104 in which reagent is heated without fuel. Step 104 is followed by step 106, in which heat is transferred from the heated reagent to the effluent including one or more undesirable compounds in the effluent to break apart the one or more undesirable compounds. In step 108, one or more desirable compounds are formed with the reagent and radicals from the one or more undesirable compounds.

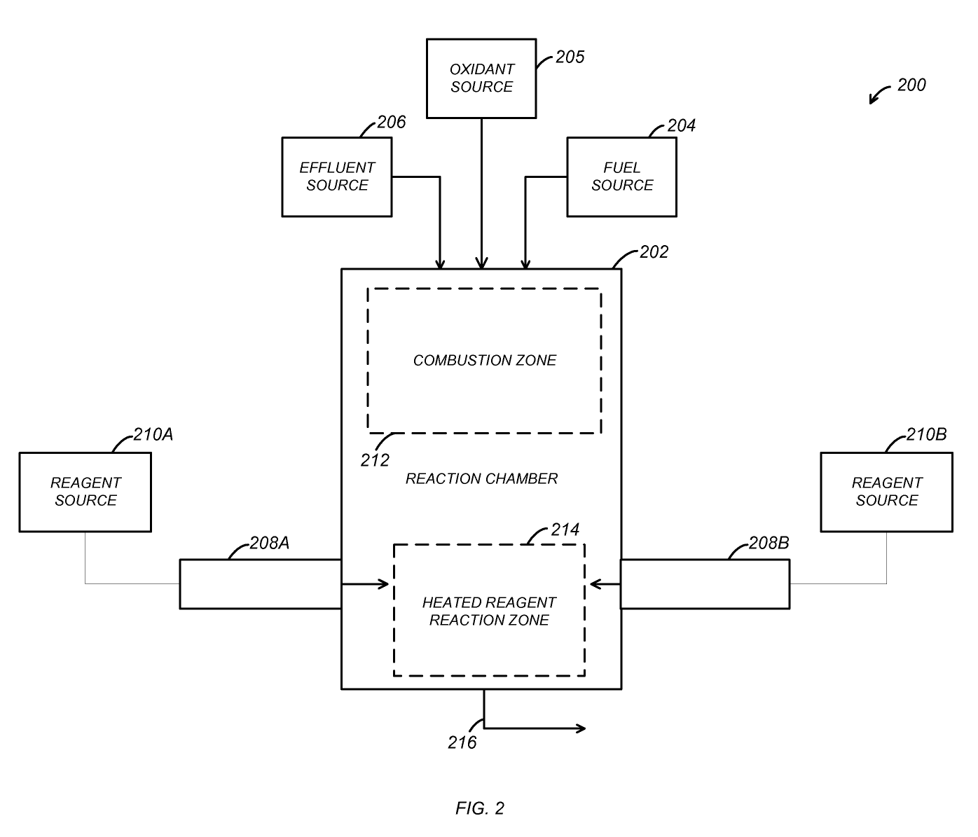

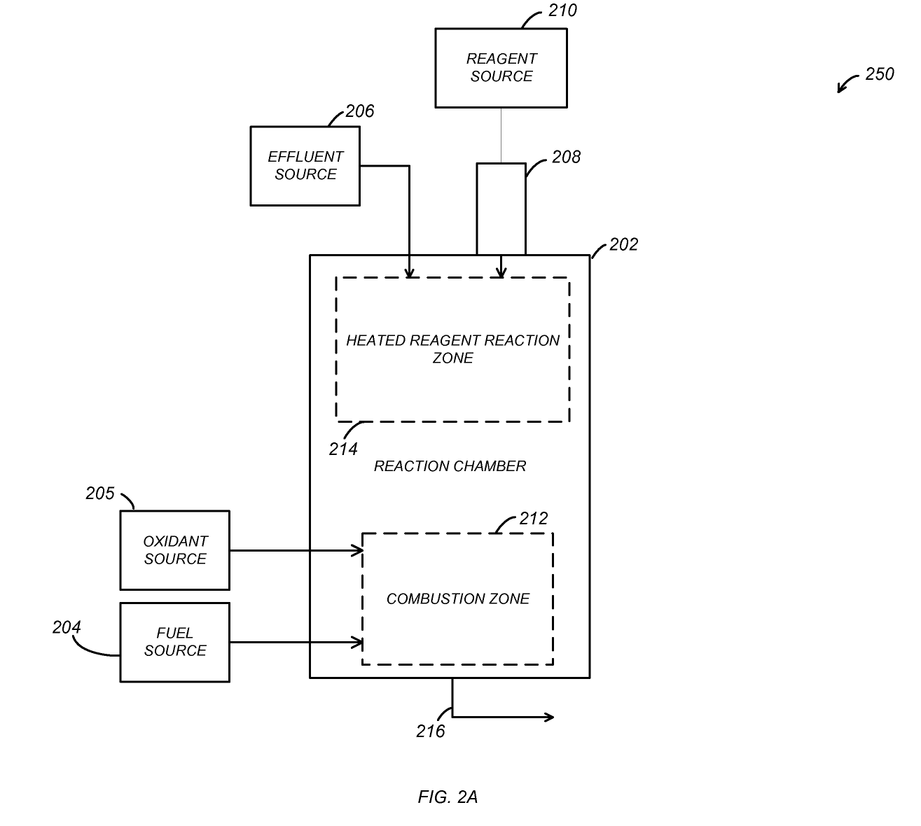

FIG. 2 depicts a schematic view of a system 200 for abating effluent provided in accordance with one embodiment of the present invention. The system 200 may include a reaction chamber 202 that is adapted to abate effluent. As depicted, the reaction chamber 202 may be coupled to a fuel source 204 that may provide a fuel and an oxidant source 205 that may provide an oxidant. The fuel and oxidant may be employed to heat and partially abate the effluent. The reaction chamber 202 may also be coupled to an effluent source 206, which may provide effluent that the reaction chamber 202 may be adapted to abate. One or more reagent heating apparatus 208a-b may be coupled to the reaction chamber 202. Although two heating conduits 208a-b are depicted, more or fewer may be employed (e.g., 1, 3, 4, etc.). One or more reagent sources 210a-b are coupled to the one or more heating apparatus 208a-b. Although two reagent sources 210a-b are depicted, more or fewer may be employed (e.g., 1, 3, 4, etc.). The reaction chamber 202 may include a combustion zone 212 that is disposed in the upstream region of the reaction chamber 202. The reaction chamber 202 may also include a heated reagent reaction zone 214 located downstream from the combustion zone 212. The heated reagent reaction zone 214 may be a reagent-heated region that is supplied with heated reagent by the two heating apparatus 208a-b. A reaction chamber outlet 216 may be coupled to an exhaust to be further abated and/or disposed.

The reaction chamber 202 may be a reaction chamber similar to that provided in the Marathon abatement system manufactured and sold by Applied Materials, Inc. (“AMAT”), although any suitable reaction chamber may be employed. The fuel source 204 may be any suitable source of fuel that may be employed in the combustion zone 212. Similar to the reaction chamber 202, the effluent source 206 may be any system that produces effluent, such as, for example, the Centura M×P+ oxide etch sold and manufactured by AMAT, although the embodiments of the present invention may be employed with any suitable electronic device manufacturing system which produces effluent. Many conventional reaction chambers employ fuel for abatement of compounds in effluent. Embodiments provided in accordance with the present invention may be employed with such conventional reaction chambers (e.g., heating apparatus may be coupled to inlets on the conventional reaction chambers). Additionally or alternatively, embodiments provided in accordance with the present invention may be employed with reaction chambers that do not use fuel.

The two heating apparatus 208a-b may be conduits adapted to heat reagent. As depicted, the two heating apparatus 208a-b may be disposed outside the reaction chamber 202. Accordingly, the two heating apparatus 208a-b may heat reagent before the reagent enters the reaction chamber 202 (i.e., preheating reagent). Although the two heating apparatus 208a-b are depicted as coupled to the downstream portion of the reaction chamber 202, the two heating apparatus 208a-b may be employed in any suitable location (e.g., upstream, inside the reaction chamber 202, etc.). For example, FIG. 2A depicts system 250 for abating effluent in accordance with one embodiment of the present invention, wherein the upstream/downstream relationship of the heated reagent reaction zone 214 and the combustion zone 212 have been reversed. In this embodiment, a reagent source 210 may supply reagent through heating apparatus 208 through the top (or upper side (not shown)) of the reactor 202. Fuel source 204 and oxidant source 205 may supply fuel and oxidant respectively to the combustion zone 212 through the side of the reaction chamber 202.

Returning to FIG. 2, the two heating apparatus 208a-b may, additionally or alternatively, be oriented in a manner different from the orientation depicted in FIG. 2. That is, the two heating apparatus 208a-b may be oriented at an angle (other than normal to the side of the reaction chamber as depicted in FIG. 2) if it is desirable to do so. For example, it may be desired to create a vortex or other similar circulation pattern to ensure a desired mixture of effluent, fuel, air, and/or reagent, etc. Thus, the heated reagent may then react with effluent in a desired manner. Such reagent may be supplied by the two reagent sources 210a-b.

The two reagent sources 210a-b may be a source of air, although any suitable source of reagent may be employed. For example, the two reagent sources 210a-b may supply compressed dry air. Although two reagent sources 210a-b are depicted, more or fewer of each of the two reagent sources 210a-b may be employed (e.g., 1, 3, 4, etc.). For example, a single reagent source 210 may be coupled to the two heating apparatus 208a-b. Additionally or alternatively, the two reagent sources 210a-b may coupled to additional reagent sources that may supply more than one reagent. For example, the two reagent sources 210a-b may be coupled to a source of pure (e.g., about 99.9% pure) molecular oxygen (O₂) (not shown) to adjust the chemical content of the heated reagent.

The combustion zone 212 and the heated reagent reaction zone 214 may be adapted to abate compounds in the effluent. As noted above, embodiments provided in accordance with the present invention may or may not include the fuel source 204. The system for abating effluent 200 depicted in FIG. 2 which does include the fuel source 204 is merely an exemplary embodiment. In this embodiment, the fuel source 204 may provide fuel that may be burned in the combustion zone 212. As depicted in FIG. 2, the heated reagent reaction zone 214 may be located downstream from the fuel source 204 and combustion zone 212. In the heated reagent reaction zone 214, heated reagent may mix with portions of effluent, remaining fuel, and/or air, etc. to further abate compounds in the effluent, as will be described below in more detail. Alternatively, the heated reagent reaction zone 214 may be located upstream of the combustion zone 212. In another alternative embodiment, there may be more than one heated reagent reaction zones 214.

In operation, the system for abating effluent 200 may abate compounds in the effluent by employing reagent heated by the two heating apparatus 208a-b. Such abatement may occur in the heated reagent reaction zone 214. Although some abatement of effluent may occur in the combustion zone 212, the temperature may not be high enough or the duration of time effluent spends (residence time) in the heated reagent reaction zone 214 may not be long enough to abate all of the undesirable compounds. Thus, effluent moving downstream from the combustion zone 212 to the heated reagent reaction zone 214 may continue to contain undesirable compounds. The heated reagent reaction zone 214 may abate such compounds with heated reagent provided by the heating apparatus 208a-b.

Radicals formed in either the combustion zone and/or in the reagent pre heat zone will result in improved abatement efficiency.

As described above, the two heating apparatus 208a-b may heat reagent supplied by the two reagent sources 210a-b as the reagent passes through the two reagents sources 210a-b to the reaction chamber 202. As depicted in FIG. 2, heated reagent may enter the reaction chamber 202 to form the heated reagent reaction zone 214. Effluent may pass into the heated reagent reaction zone 214 where the reagent may heat or further heat the effluent and any undesirable compounds therein. Such heating may breakdown the undesirable compounds into radicals that combine (react) with the reagent to form one or more desirable compounds. The temperature required to break apart the undesirable compounds in the heated reagent reaction zone 214 may be about 1400° C., although higher or lower temperatures (heat levels) may be employed. For example, temperatures selected from the range of about 800° C.-1800° C., or about 1300° C.-1500° C. may be used. Such temperatures may not be feasible and/or desirable to achieve with combusted fuel alone. Effluent abated by the heated reagent reaction zone 214 may exit the reaction chamber 202 at the reaction chamber outlet 216 where it may enter a scrubber, a facilities exhaust or a house scrubber, for example.

In an alternative embodiment, effluent may pass through a wet or dry scrubber prior to being abated in the reaction chamber 202 and/or after being abated in the reaction chamber 202.

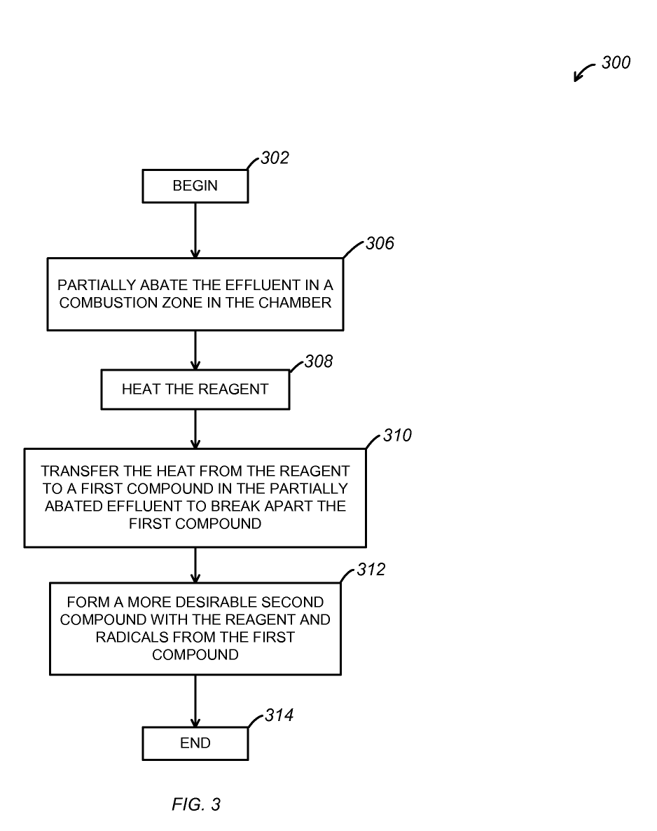

FIG. 3 depicts a flow chart of a second method 300 of forming a more desirable compound with heated reagent provided in accordance with the present invention. The second method 300 employs heated reagent to form one or more desirable compounds from effluent which has been partially abated by a fuel source. The second method 300 begins with step 302. In step 306, the system for abating effluent 300 partially abates the effluent in a combustion zone in the chamber to form partially abated effluent. In step 308, reagent may be heated. In step 310, heat may be transferred from the reagent to an undesirable compound in the partially abated effluent to break apart the undesirable compound to form radicals. In step 312, the reagent may react with the radicals to form a more desirable compound. The second method of abating effluent 300 ends in step 314.

Accordingly, the second method 300 may abate effluent without using an undesirable amount of fuel. That is, an acceptable amount of fuel is employed to partially abate effluent. Effluent compounds that require a higher temperature to break apart (e.g., a higher temperature than may be created in the combustion zone of the reaction chamber) are heated in step 310 using heated reagent, to form the more desirable compounds. An additional advantage of the second method is that abatement process 300 may be optimized. For example, referring to FIG. 2, the combustion zone 212 may employ a first reagent that is chemically different from a heated reagent employed in the heated reagent reaction zone 214. In this way, particularly useful reagents may be selected independently for the combustion zone 212 and the heated reagent zone 214.

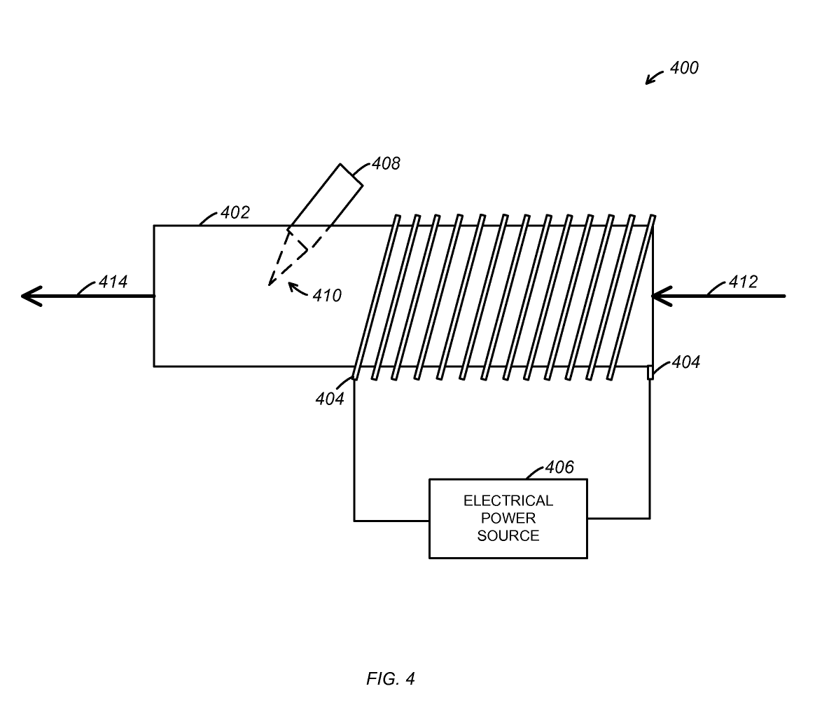

FIG. 4 depicts a side view of an exemplary heating conduit 400 provided in accordance with the present invention. The exemplary heating conduit 400 may be used as the heating apparatus 208a-b described above with reference to FIG. 2. As depicted in FIG. 4, the exemplary heating conduit 400 may include a conduit 402 that may be surrounded by a heating element 404. The conduit 402 may be constructed of any material which may withstand the temperatures created inside of the conduit 402, and which may not react with heated reagent which may be formed within the conduit 402. For example, the conduit 402 may be made of a ceramic material, and/or a metal. The heating element 404 may be coupled to an electrical power source 406 that may provide electrical power to the heating element 404. The conduit 402 may also have a plasma source 408 to inject plasma 410 into the reagent stream to form an ionized reagent zone. In another alternative embodiment, appropriate electrodes (not shown) may be located within the conduit 402 in order to create a plasma within the conduit 402. Reagent may enter the conduit 402 at a conduit inlet 412 and exit at a conduit outlet 414.

The conduit 402 may be a high temperature conduit although any suitable conduit may be employed. For example, the conduit may be a ceramic conduit that is cylindrically shaped. Although the conduit 402 is depicted as cylindrically shaped, any suitable shape may be employed. The conduit 402 may be made of material that is functional in the temperature range of the heated reagent. For example, if heated reagent is about 1400° C. then the conduit 402 may need to be functional at about this temperature. In addition, due to heat loss and other considerations, the conduit 402 may need to be functional at temperatures higher than heated reagent. Accordingly, the conduit 402 may be made of a high temperature ceramic and/or alloy (e.g., exotic metal, yttria alumina ceramic, etc.). To heat reagent via the conduit 402, the conduit 402 may be surrounded by a heating element 404 that may heat reagent directly and/or indirectly, as will be described below in more detail.

In one example, the heating element 404 may be an irradiative heater (e.g., infrared radiator) that illuminates the outside of the conduit 402. Accordingly, the conduit 402 may heat reagent to a desired temperature. As depicted, the heating element 404 may be a coil shaped heating element comprised of molybdenum silicide, for example, although any suitable shape and/or material may be employed. To heat reagent to the desired temperature, electricity may be supplied to the heating element 404 by the electrical power source 406. Although the heating element 404 heats the reagent, it is possible that additional heating will be desired. Such additional heating may be provided by the plasma torch 408.

The plasma torch 408 may be a spark gap plasma torch although any suitable heating mechanism may be employed. As depicted, the plasma torch 408 is disposed partially inside the conduit inlet 412. The plasma torch 408 may provide a high temperature plasma 410 that may be initiated by a spark gap. In alternative embodiments, the plasma torch 408 may be something other than a spark gap plasma torch. For example, the plasma torch 408 may be a radio frequency (RF) heater. That is, the plasma torch 408 may heat reagent by coupling RF power to reagent flowing through the conduit 402. In such an embodiment, the plasma torch 408 may not necessarily be disposed (e.g., partially, fully, etc.) internal to the conduit 402.

Variations of the above combination of heaters may also be employed. Although the exemplary heating conduit 400 depicts two heaters (the heating element 404 and the plasma torch 408) more or fewer and different types of heaters may be employed. For example, reagent may be heated with a plasma torch and the radio frequency heater, but not an element heater.

In operation, the heating conduit 400 may heat reagent as reagent flows from the conduit inlet 412 to the conduit outlet 414. As noted above, the heating element 404 may heat reagent to a temperature that may not be sufficient for the abatement of some compounds. Thereafter, the plasma torch 408 may further heat reagent to a temperature which is sufficient to abate such compounds. Subsequently, heated reagent may be flowed into the reaction chamber 202 (FIG. 2) to react with effluent in the heated reagent reaction zone 214. Accordingly, heated reagent may heat effluent to the temperature required to break apart the effluent compounds without the use of fuel.

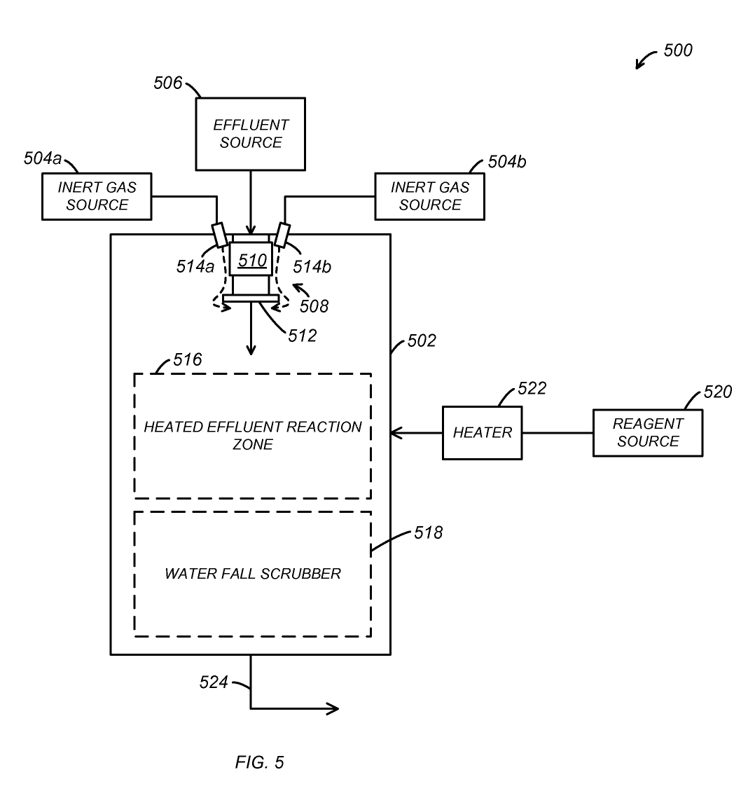

FIG. 5 depicts a heated effluent abatement system 500 provided in accordance with the present invention. The heated effluent abatement system 500 may heat effluent directly rather than heat effluent with heated reagent as described above with reference to FIGS. 1-4. Additional features are also disclosed which may be employed with any suitable embodiments provided in accordance with the present invention, including those described with reference to FIGS. 1-4. As depicted, the heated effluent abatement system 500 may include a heated effluent reaction chamber 502 that may be coupled to one or more inert gas sources 504a-b and one or more effluent sources 506. The heated effluent reaction chamber 502 may also be coupled to a conduit 508 which may be similar to the exemplary heating conduit 400 described with reference to FIG. 4. As depicted, the conduit 508 may be coupled to a heating element 510 and an effluent plasma torch 512. The heating element 510 may also be surrounded by a sheath of gas provided by gas nozzles 514a-b that may be coupled to the heated effluent reaction chamber 502. Nozzles 514a-b may be any suitably shaped nozzles. For example, a single annular nozzle surrounding conduit 508 may be employed. Inside the reaction chamber 502 may be a main reactor furnace 516 and a waterfall scrubber 518. The heated effluent reaction chamber 502 may be coupled to reagent source 520 through an optional heater 522, and an exhaust 524, which may be coupled to a facilities exhaust.

The heated effluent abatement system 500 may be similar to the system for abating effluent 200 described with reference to FIG. 2 and may include features similar to the exemplary heating conduit 400 described with reference to FIG. 4. The heated effluent reaction chamber 502 may be a reactor chamber that is similar to the reaction chamber 202 in form and function. Similarly, the effluent source 506 may be similar to the effluent source 206. The conduit 508 may be similar to the conduit 402 described with reference to FIG. 4. The heating element 510 may be similar to the heating element 404 and the effluent plasma torch 512 may be similar to the plasma torch 408 described with reference to FIG. 4. The heated effluent abatement system 500 may also include a main reactor furnace 516 and a waterfall scrubber 518. The heated effluent abatement system 500 may also include an inert gas sheath provided by the two gas nozzles 514a-b.

The two gas nozzles 514a-b may flow inert gas into the heated effluent reaction chamber 502, although any suitable source of gas and/or fluid may be employed. The inert gas may be employed to provide a sheath of gas around the conduit 508, heating element 510, and effluent plasma torch 512. As depicted, the two gas nozzles 514a-b may be gas nozzles suitable for dispensing an inert gas (e.g., He, N₂, etc.) and made be oriented at an angle. The angle may be selected such that inert gas surrounds the conduit 508, heating element 510, and effluent plasma torch 512. Additionally, the nozzle may be adapted to blow the inert gas at a pressure and velocity that is suited to flow the inert gas in a desired manner. The inert gas flow may also curve to create a region of inert gas disposed downstream of the effluent plasma torch 512. In this manner, effluent in the conduit 508 may be temporarily isolated from reagents, fuel, or the like in the heated effluent reaction chamber 502.

In operation, heated effluent may flow from the conduit 508 to the reaction chamber 502, wherein the heated effluent abatement system 500 may abate the heated effluent. As discussed above, effluent may be heated to a temperature that breaks the effluent compounds apart in the conduit 508. The sheath of inert gas around the heated effluent may prevent the heated effluent from reacting with reagents temporarily while the heated effluent is in the heated effluent reaction chamber 502 and before the heated effluent reaches main reactor furnace 516. Thus, heated effluent may flow into the heated effluent reaction chamber 502 and into the main reactor furnace 516. In the main reactor furnace 516, heated effluent may react with reagent. The reagent may or may not itself be heated by, for example, optional reagent heater 522. The reagent heater 522 may be similar to the heating conduit 400 of FIG. 4. Such reagent may be provided in accordance with the apparatus and methods described with reference to FIGS. 1-4. That is, heated reagent may be employed to react with heated effluent in the main reactor furnace 516. Although reagent is shown in FIG. 5 as entering the reactor 502 through the side, it should be understood that reagent may enter the reactor 502 through the top as well.

The foregoing description discloses only exemplary embodiments of the invention. Modifications of the above disclosed apparatus and methods that fall within the scope of the invention would be readily apparent to those of ordinary skill in the art. For instance, the use of fuel in an abatement system may be eliminated. In such an embodiment, the undesirable chemistry may include compounds that require a lower temperature to ‘break apart’ (e.g., NF₃). Thus, the reagent may be heated to a temperature sufficient for such compounds, if desired. Thus, it would be obvious to one of ordinary skill in the art to modify the embodiments in accordance with the present invention to abate different effluents. Additionally or alternatively, embodiments provided in accordance with the present invention may include a plurality of chambers (e.g., as chamber stages) wherein each chamber heats an effluent flow with reagents supplied at different temperatures (e.g., T₁ₛₜ=300° C., T_{2nd}=400° C., etc.).

Accordingly, while the present invention has been disclosed in connection with exemplary embodiments thereof, it should be understood that other embodiments may fall within the spirit and scope of the invention, as defined by the following claims.

1. An apparatus for abating effluent from an electronic device manufacturing process tool, comprising:
a reaction chamber adapted to receive an effluent; and
a reagent heating apparatus in fluid connection with the reaction chamber;
wherein the reagent heating apparatus is adapted to heat a reagent and to introduce the heated reagent into a heated reagent reaction zone of the reaction chamber; and
wherein the reaction chamber is further adapted to mix the effluent and the heated reagent in the heated reagent reaction zone.

2. The apparatus of claim 1, wherein the reagent heating apparatus comprises a resistive heater.

3. The apparatus of claim 1, wherein the reagent heating apparatus comprises a plasma torch.

4. The apparatus of claim 1, wherein the reagent heating apparatus comprises a resistive heater and a plasma torch.

5. The apparatus of claim 1, wherein the reaction chamber is further adapted to receive a fuel and to combust the fuel in a combustion zone of the reaction chamber.

6. The apparatus of claim 5, wherein the combustion zone of the reaction chamber is situated upstream from the heated reagent reaction zone of the reaction chamber.

7. The apparatus of claim 5, wherein the combustion zone of the reaction chamber is situated downstream from the heated reagent reaction zone of the reaction chamber.

8. An apparatus for abating effluent from an electronic device manufacturing process tool, comprising:
an effluent heating apparatus adapted to heat an effluent without burning a fuel; and
a reaction chamber;
wherein the effluent heating apparatus is further adapted to introduce the heated effluent into the reaction chamber; and
wherein the reaction chamber is adapted to receive a reagent into the heated effluent reaction zone and to mix the heated effluent with the reagent in the heated effluent reaction zone, whereby the heated effluent is abated.

9. The apparatus of claim 8, wherein the effluent heating apparatus comprises a resistive heater.

10. The apparatus of claim 8, wherein the effluent heating apparatus comprises a plasma torch.

11. The apparatus of claim 8, wherein the effluent heating apparatus comprises a resistive heater and a plasma torch.

12. The apparatus of claim 8, wherein the reaction chamber is further adapted to receive a combustible fuel and to combust the fuel in a combustion zone of the reaction chamber.

13. The apparatus of claim 12, wherein the combustion zone of the reaction chamber is situated downstream from the heated effluent reaction zone of the reaction chamber.

14. The apparatus of claim 8, further comprising an inert gas nozzle adapted to sheathe the heated effluent with inert gas as the heated effluent exits the effluent heating apparatus.

15. The apparatus of claim 8, further comprising a waterfall scrubber located downstream from the heated effluent reaction zone of the reaction chamber.

16. The apparatus of claim 8, further comprising a reagent heating apparatus which is adapted to heat the reagent and to introduce the heated reagent into the heated effluent reaction zone of the reaction chamber.

17. A method for abating effluent from an electronic device manufacturing process tool, comprising:
heating a reagent;
mixing the heated reagent with an effluent in a heated reagent reaction zone of a reaction chamber, whereby heat is transferred from the heated reagent to the effluent; and
reacting the effluent with the heated reagent, whereby the effluent is abated.

18. The method of claim 17, further comprising:
combusting a fuel in a combustion zone of the reaction chamber; and
flowing the effluent into the combustion zone of the reaction chamber, whereby a portion of the effluent is abated.

19. The method of claim 18, wherein the effluent is flowed into the combustion zone of the reaction chamber before the effluent is mixed with the heated reagent in the heated reagent reaction zone of the reaction chamber.

20. The method of claim 17, wherein the step of heating the reagent further comprises heating the reagent with a resistive heater.

21. The method of claim 17, wherein the step of heating the reagent further comprises heating the reagent with a plasma torch.

22. A method for abating effluent from an electronic device manufacturing process tool, comprising:
heating an effluent without combusting a fuel;
mixing the heated effluent with a reagent in a heated effluent reaction zone of a reaction chamber, whereby heat is transferred from the heated effluent to the reagent; and
reacting the heated effluent with the reagent, whereby the effluent is abated.

23. The method of claim 22, wherein the effluent is heated with a resistive heater.

24. The method of claim 22, wherein the effluent is heated with a plasma torch.

25. The method of claim 22, wherein the reagent is heated prior to mixing the heated effluent with the reagent in the heated effluent reaction zone of the reaction chamber.
